(19) United States
(12) Patent Application Publication
(10) Pub. No.: US 2009/0003960 A1
(43) Pub. Date: Jan. 1, 2009

(54) Bolt and Washer Assembly Having Self-Locking and Burglarproof Functions

(76) Inventor: Chen-Mao Lin, Rende Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/768,404

(22) Filed: Jun. 26, 2007

(51) Int. Cl. F16B 39/24

(52) U.S. Cl. 411/161

(57) ABSTRACT

A bolt and washer assembly includes a washer, and a bolt including a threaded rod extended through the washer and a bolt head mounted on the threaded rod. The bolt head of the bolt has a top formed with a protruding ring and a circular recessed portion which is encompassed by the protruding ring and provided with at least two ratchet teeth. Thus, the bolt head has a peripheral wall having a smooth cone-shaped configuration so that the bolt head is operated by a special tool, and a person cannot use a common tool to hold the bolt head to rotate the bolt so as to prevent the bolt from being unscrewed from the workpiece so that the bolt and washer assembly has a burglarproof function.

### BACKGROUND OF THE INVENTION

1. Field of the Invention

The present invention relates to a bolt and washer assembly and, more particularly, to a bolt and washer assembly.

2. Description of the Related Art

A conventional bolt and washer assembly in accordance with the prior art shown in FIG. 4 comprises a washer 20, and a bolt 10 mounted on the washer 20 and including a threaded rod 12 extended through the washer 20 and a bolt head 11 mounted on the threaded rod 12. The washer 20 has a periphery formed with two radially opposite openings 24 to allow insertion of an auxiliary tool (not shown). The washer 20 has a top formed with a plurality of first wedge-shaped surfaces 21 and a bottom formed with a plurality of engaging strips 23. Each of the first wedge-shaped surfaces 21 of the washer 20 is formed by a wedge-shaped tooth 22 which consists of a ramp 222 and a vertical catch face 221. The bolt head 11 of the bolt 10 has a hexagonal peripheral wall and has a bottom formed with a plurality of second wedge-shaped surfaces 111 engaged with the first wedge-shaped surfaces 21 of the washer 20.

In operation, the bolt 10 is rotatable to screw the threaded rod 12 into a workpiece 30. At this time, the second wedge-shaped surfaces 111 of the bolt head 11 of the bolt 10 are engaged with the first wedge-shaped surfaces 21 of the washer 20 so that the washer 20 is rotatable with of the bolt 10 in the normal direction and is movable toward the workpiece 30 until the washer 20 is clamped between the bolt head 11 of the bolt 10 and the workpiece 30. When the washer 20 is clamped between the bolt head 11 of the bolt 10 and the workpiece 30, each of the engaging strips 23 of the washer 20 is inserted into and locked in a surface of the workpiece 30 to prevent the washer 20 from being rotated relative to the workpiece 30 in the opposite direction. At this time, when the bolt 10 is rotated in the opposite direction, the first wedge-shaped surfaces 21 of the washer 20 interfere with the second wedge-shaped surfaces 111 of the bolt head 11 of the bolt 10 so that the bolt 10 cannot be rotated in the opposite direction to prevent the bolt 10 from being unscrewed from the workpiece 30. Thus, the bolt 10 is screwed into the workpiece 30 easily and cannot be unscrewed from the workpiece 30 to provide a self-locking function. When a user wishes to unscrew the bolt 10 from the workpiece 30, the auxiliary tool is inserted into the openings 24 of the washer 20 to position the washer 20 so that the bolt 10 can be unscrewed from the workpiece 30 by rotating the bolt 10 in the opposite direction.

However, a person can provide a violent force on the bolt 10 to rotate the bolt 10 in the opposite direction so as to unscrew the bolt 10 from the workpiece 30, so that the conventional bolt and washer assembly does not have a burglarproof function.

### BRIEF SUMMARY OF THE INVENTION

In accordance with the present invention, there is provided a bolt and washer assembly, comprising a washer having a central portion formed with a through hole, and a bolt mounted on the washer and including a threaded rod extended through the through hole of the washer and a bolt head mounted on the threaded rod. The bolt head of the bolt has a peripheral wall having a smooth cone-shaped configuration and has a top formed with a protruding ring and a circular recessed portion which is encompassed by the protruding ring and provided with at least two ratchet teeth.

The primary objective of the present invention is to provide a bolt and washer assembly having self-locking and burglarproof functions.

Another objective of the present invention is to provide a bolt and washer assembly, wherein the bolt head of the bolt has a peripheral wall having a smooth cone-shaped configuration so that the bolt head of the bolt is operated by the special tool, and a person cannot use a common tool to hold the bolt head of the bolt to rotate the bolt so as to prevent the bolt from being unscrewed from the workpiece so that the bolt and washer assembly has a burglarproof function.

A further objective of the present invention is to provide a bolt and washer assembly, wherein the bolt is screwed into the workpiece easily and cannot be unscrewed from the workpiece so that the bolt and washer assembly has a self-locking function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a bolt and washer assembly in accordance with the preferred embodiment of the present invention.

FIG. 2 is a front cross-sectional assembly view of the bolt and washer assembly as shown in FIG. 1.

FIG. 3 is a partially perspective operational view of the bolt and washer assembly as shown in FIG. 1.

FIG. 4 is an exploded perspective view of a conventional bolt and washer assembly in accordance with the prior art.

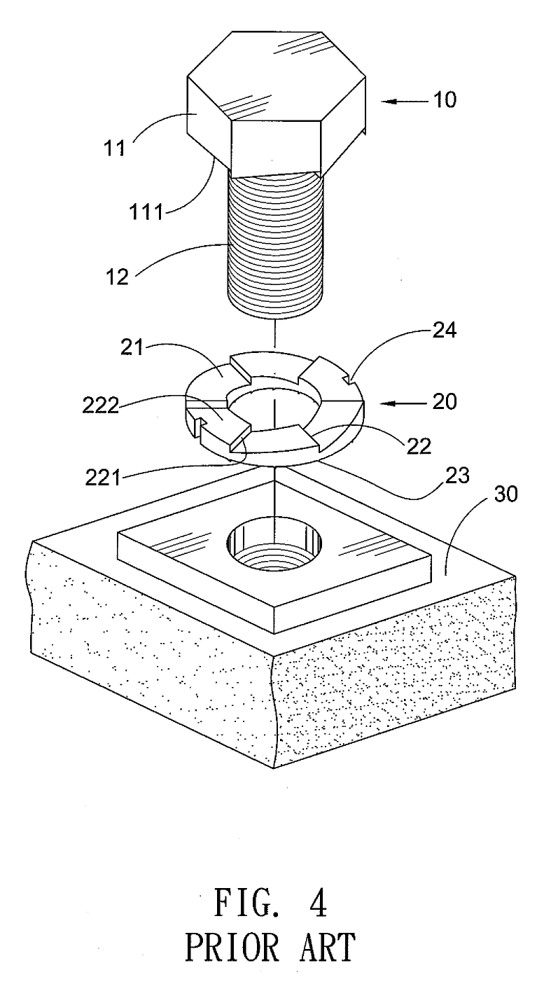

### DETAILED DESCRIPTION OF THE INVENTION

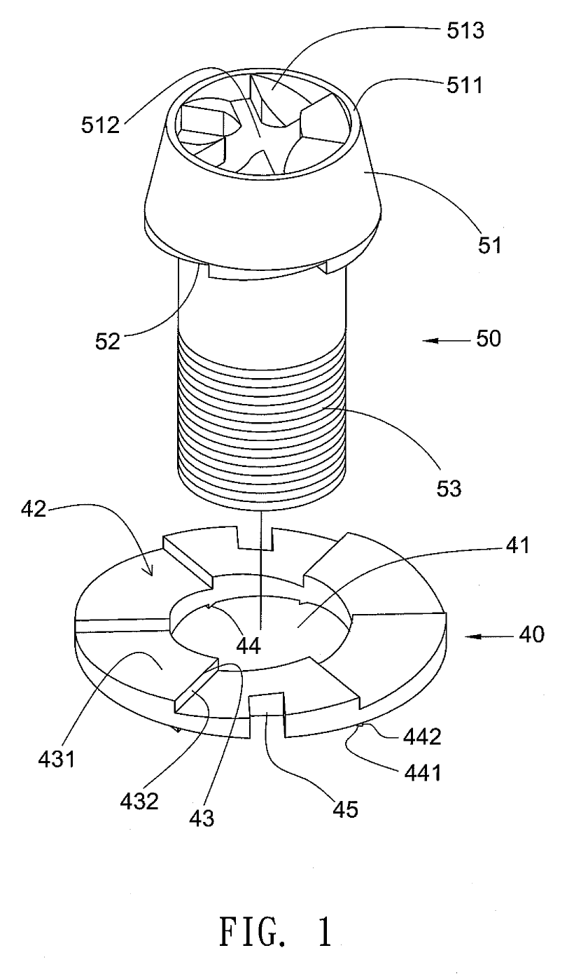

Referring to the drawings and initially to FIG. 1, a bolt and washer assembly in accordance with the preferred embodiment of the present invention comprises a washer 40 having a central portion formed with a through hole 41, and a bolt 50 mounted on the washer 40 and including a threaded rod 53 extended through the through hole 41 of the washer 40 and a bolt head 51 mounted on the threaded rod 53.

The washer 40 has a circular shape and has a periphery formed with at least two radially opposite openings 45 to allow insertion of an auxiliary tool (not shown). The washer 40 has a top formed with a plurality of first wedge-shaped surfaces 42 and a bottom formed with a plurality of engaging strips 44. Each of the first wedge-shaped surfaces 42 of the washer 40 is formed by a oneway wedge-shaped tooth 43 which consists of a ramp 431 and a vertical catch face 432. The ramp 431 of the oneway wedge-shaped tooth 43 of each of the first wedge-shaped surfaces 42 of the washer 40 has an outer edge and an outer edge having an equal height at the same center angle of the washer 40. The engaging strips 44 of the washer 40 are arranged in a radiating manner. Each of the engaging strips 44 of the washer 40 consists of a ramp 441 and a vertical wall 442. The ramp 441 of each of the engaging strips 44 of the washer 40 has a direction corresponding to a screwing direction of the bolt 50.

The bolt head 51 of the bolt 50 has a peripheral wall having a smooth cone-shaped configuration and has a top formed with a protruding ring 511 and a circular recessed portion 512 which is encompassed by the protruding ring 511 and provided with at least two ratchet teeth 513. The ratchet teeth 513 of the bolt head 51 of the bolt 50 are hidden in the protruding ring 511 and are arranged radially opposite to each other. The ratchet teeth 513 of the bolt head 51 of the bolt 50 are equally or non-equally spaced from each other. Preferably, the bolt head 51 of the bolt 50 has a plurality of radially opposite ratchet teeth 513 which are arranged in a radiating manner. The bolt head 51 of the bolt 50 has a bottom formed with a plurality of second wedge-shaped surfaces 52 engaged with the first wedge-shaped surfaces 42 of the washer 40.

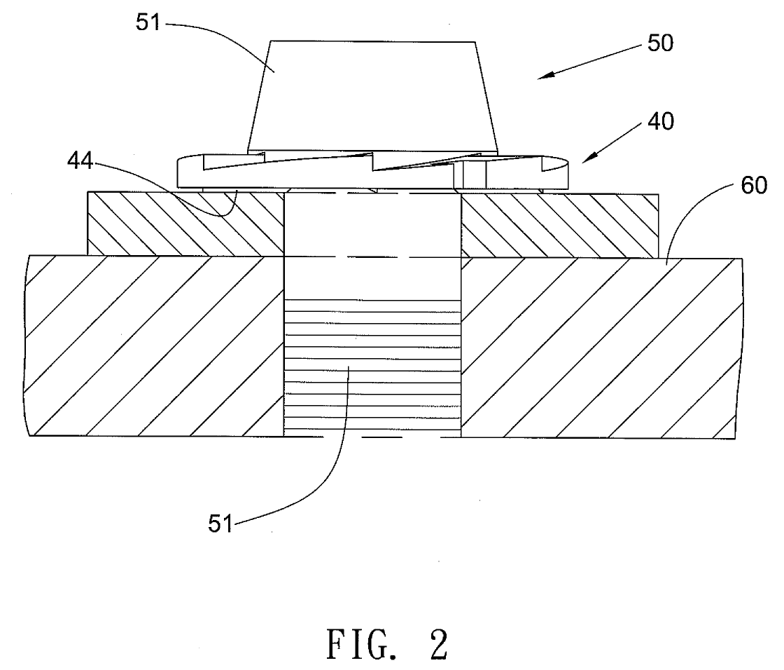

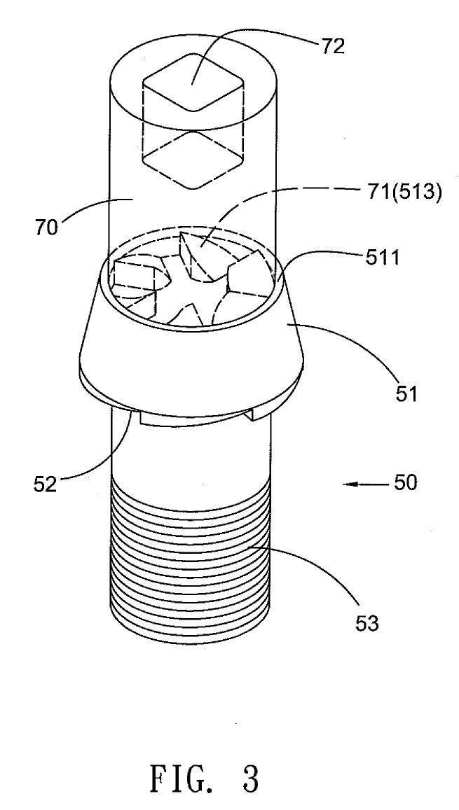

In operation, referring to FIGS. 1-3, a special tool 70 is mounted on the bolt head 51 of the bolt 50 and has a first end portion formed with a plurality of tooth-shaped engaging grooves 71 engaged with the ratchet teeth 513 of the bolt head 51 of the bolt 50 and a second end portion formed with a square mounting hole 72 to allow insertion of a drive stud (not shown) of a wrench (not shown). In such a manner, the engaging grooves 71 of the special tool 70 are engaged with the ratchet teeth 513 of the bolt head 51 of the bolt 50 so that the special tool 70 is rotatable to rotate the bolt 50 which rotates the threaded rod 53 which is screwed into a workpiece 60. At this time, the second wedge-shaped surfaces 52 of the bolt head 51 of the bolt 50 are engaged with the first wedge-shaped surfaces 42 of the washer 40 so that the washer 40 is rotatable with of the bolt 50 in the normal direction and is movable toward the workpiece 60 until the washer 40 is clamped between the bolt head 51 of the bolt 50 and the workpiece 60.

When the washer 40 is clamped between the bolt head 51 of the bolt 50 and the workpiece 60, each of the engaging strips 44 of the washer 40 is inserted into and locked in a surface of the workpiece 60 to prevent the washer 40 from being rotated relative to the workpiece 60 in the opposite direction. At this time, when the bolt 50 is rotated in the opposite direction, the first wedge-shaped surfaces 42 of the washer 40 interfere with the second wedge-shaped surfaces 52 of the bolt head 51 of the bolt 50 so that the bolt 50 cannot be rotated in the opposite direction to prevent the bolt 50 from being unscrewed from the workpiece 60. Thus, the bolt 50 is screwed into the workpiece 60 easily and cannot be unscrewed from the workpiece 60 to provide a self-locking function.

When a user wishes to unscrew the bolt 50 from the workpiece 60, the auxiliary tool is inserted into the openings 45 of the washer 40 to position the washer 40 so that the bolt 50 can be unscrewed from the workpiece 60 by rotating the special tool 70 in the opposite direction.

Accordingly, the bolt head 51 of the bolt 50 has a peripheral wall having a smooth cone-shaped configuration so that the bolt head 51 of the bolt 50 is operated by the special tool 70, and a person cannot use a common tool to hold the bolt head 51 of the bolt 50 to rotate the bolt 50 so as to prevent the bolt 50 from being unscrewed from the workpiece 60 so that the bolt and washer assembly has a burglarproof function. In addition, the bolt 50 is screwed into the workpiece 60 easily and cannot be unscrewed from the workpiece 60 so that the bolt and washer assembly has a self-locking function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bolt and washer assembly, comprising:
a washer having a central portion formed with a through hole;
a bolt mounted on the washer and including a threaded rod extended through the through hole of the washer and a bolt head mounted on the threaded rod, wherein
the bolt head of the bolt has a peripheral wall having a smooth cone-shaped configuration;
the bolt head of the bolt has a top formed with a protruding ring and a circular recessed portion which is encompassed by the protruding ring and provided with at least two ratchet teeth.

2. The bolt and washer assembly in accordance with claim 1, wherein the ratchet teeth of the bolt head of the bolt are hidden in the protruding ring.

3. The bolt and washer assembly in accordance with claim 1, wherein the ratchet teeth of the bolt head of the bolt are arranged radially opposite to each other.

4. The bolt and washer assembly in accordance with claim 1, wherein the ratchet teeth of the bolt head of the bolt are equally spaced from each other.

5. The bolt and washer assembly in accordance with claim 1, wherein the ratchet teeth of the bolt head of the bolt are non-equally spaced from each other.

6. The bolt and washer assembly in accordance with claim 1, wherein the bolt head of the bolt has a plurality of radially opposite ratchet teeth which are arranged in a radiating manner.

7. The bolt and washer assembly in accordance with claim 1, further comprising a special tool mounted on the bolt head of the bolt and having a first end portion formed with a plurality of tooth-shaped engaging grooves engaged with the ratchet teeth of the bolt head of the bolt.

8. The bolt and washer assembly in accordance with claim 7, wherein the special tool has a second end portion formed with a square mounting hole.

9. The bolt and washer assembly in accordance with claim 1, wherein:
the washer has a top formed with a plurality of first wedge-shaped surfaces and a bottom formed with a plurality of engaging strips;
the bolt head of the bolt has a bottom formed with a plurality of second wedge-shaped surfaces engaged with the first wedge-shaped surfaces of the washer.

10. The bolt and washer assembly in accordance with claim 9, wherein each of the first wedge-shaped surfaces of the washer is formed by a oneway wedge-shaped tooth which consists of a ramp and a vertical catch face.

11. The bolt and washer assembly in accordance with claim 10, wherein the ramp of the oneway wedge-shaped tooth of each of the first wedge-shaped surfaces of the washer has an outer edge and an outer edge having an equal height at the same center angle of the washer.

12. The bolt and washer assembly in accordance with claim 9, wherein the engaging strips of the washer are arranged in a radiating manner.

13. The bolt and washer assembly in accordance with claim 9, wherein each of the engaging strips of the washer consists of a ramp and a vertical wall.

14. The bolt and washer assembly in accordance with claim 9, wherein the ramp of each of the engaging strips of the washer has a direction corresponding to a screwing direction of the bolt.

15. The bolt and washer assembly in accordance with claim 7, wherein the special tool is rotatable to rotate the bolt.

16. The bolt and washer assembly in accordance with claim 1, wherein the washer has a circular shape.

17. The bolt and washer assembly in accordance with claim 1, wherein the washer has a periphery formed with at least two radially opposite openings.
